(19) United States
(12) Patent Application Publication
(10) Pub. No.: US 2008/0070557 A1
(43) Pub. Date: Mar. 20, 2008

(54) METHOD FOR SIGNALING VIRTUAL MULTI-ACCESS PLATFORMS

(75) Inventors: Toni Paila, Rye, NY (US); Eero Jyske, Irving, TX (US); Martin Jansky, Espoo (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/855,473

(22) Filed: Sep. 14, 2007

Related U.S. Application Data
(60) Provisional application No. 60/825,674, filed on Sep. 14, 2006.

(51) Int. Cl. H04M 3/42; H04M 1/00; H04Q 7/22

(52) U.S. Cl. 455/414.1; 455/550.1

(57) ABSTRACT

Provided are apparatuses and methods for signaling and identifying platforms that carry services or channels over multiple bearers. The bearers of a platform may be one or more different technologies. The services within one bearer may be carried over another bearer belonging to the same virtual platform. Provider bound services may be identified by a terminal over a range of different technologies.

This application claims the benefit of U.S. Provisional Application No. 60/825,674, filed Sep. 14, 2006. The entire disclosure of which is herein incorporated by reference.

### TECHNICAL FIELD

Aspects of the invention relate generally to communications networks. More specifically, aspects of the invention relate to signaling and identifying platforms that carry channels or services over multiple bearers in communication networks.

### BACKGROUND

Digital broadband broadcast networks enable users to receive digital content including video, audio, data, and so forth. Users may receive programs or services via a multitude of alternative access methods. The receipt of programs or services via these alternative access methods may produce the same or similar user experience. This hybrid delivery and consumption model may be referred to as “multi-access.” An example of a multi-access service includes a mobile broadcasting service with mobile TV channels. For instance, for a single mobile TV service and/or channel there may be a multitude of alternative or complementing access methods that enable the user to enjoy the mobile TV service and/or channel regardless of whether the user connects to the service or otherwise receives it over 3rd Generation (3G) cellular system, 3G multicast/broadcast system (MBMS), 3G High-Speed Downlink Packet Access (HSDPA) system, 3rd Generation Partnership Project (3GPP), 3rd Generation Partnership Project 2 (3GPP2), Wireless Local Area Network (WLAN) system, Worldwide Interoperability for Microwave Access (WiMAX) system, Digital Video Broadcasting-Handheld (DVB-H), Digital Video Broadcast-Terrestrial (DVB-T), Digital Multimedia Broadcasting (DMB), Forward Link Only (FLO), MediaFLO system, or any other digital or non-digital communications or broadcasting system or any combination of the above systems.

A multi-access capable terminal is typically needed to consume or access multi-access service that utilizes different physical bearers. However, multi-access may also be provided within a single physical bearer technology in which case the multi-access device may also implement only one bearer technology. For example, multi-access may be provided within a single bearer technology such as DVB-H. A DVB-H network may carry multiple transport streams with each transport stream possibly carrying a multiplex of Digital Video Broadcasting (DVB) services. A multiplex may be defined by the identification of the network of origin and the carrying transport stream identification.

A provider of service may make their services or programs available via many different bearers using a multitude of specifications in order to reach end users of that service or program. In addition, a provider of multi-access services typically administers and manages the services over multiple platforms.

Currently, there is no method for a terminal to identify which accesses deliver which services using which specifications and how those accesses and services relate to the provider over a range of different technologies. Similarly, the provider of the service is not able to retain a coherent and simple view to the end user of the service or program.

Hence, there is a need for efficient and effective methods and systems for signaling and identifying platforms that carry channels or services over multiple bearers in communication networks.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates an example of a wireless communication system in which one or more illustrative embodiments of the invention may be implemented.

FIG. 2 illustrates an example of a terminal device in accordance with an aspect of the invention.

FIG. 3 illustrates an exemplary virtual platform declaration message in accordance with an aspect of the invention.

FIG. 4 illustrates a flow diagram showing the creation and transmission of a virtual platform declaration message in accordance with an aspect of the invention.

FIG. 5 illustrates a flow diagram showing the receipt of a virtual platform declaration message by a terminal in accordance with an aspect of the invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

It is noted that various connections are set forth between elements in the following description. It is noted that these connections in general and, unless specified otherwise, may be direct or indirect and that this specification is not intended to be limiting in this respect.

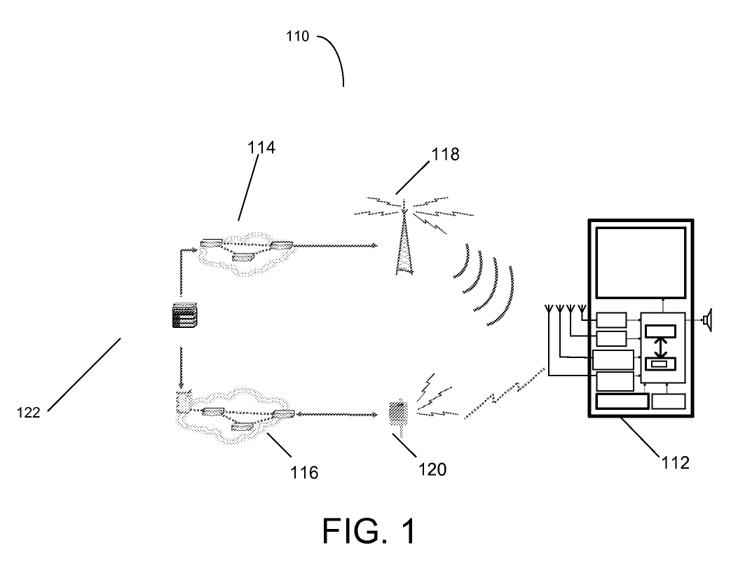

FIG. 1 illustrates an example of a wireless communication system 110 in which the systems and methods of the present invention may be advantageously employed. One or more network-enabled mobile devices 112, such as a personal digital assistant (PDA), cellular telephone, mobile terminal, personal video recorder, portable or fixed television, personal computer, digital camera, digital camcorder, portable audio device, portable or fixed analog or digital radio, or combinations thereof, are in communication with a service source 122 through a broadcast network 114 and/or cellular network 116. The mobile terminal/device 112 may comprise a digital broadcast receiver device. The service source 122 may be connected to several service providers that may provide their actual program content or information or description of their services and programs to the service source that further provides the content or information to the mobile device 112. The several service providers may include but are not limited to one or more television and/or digital television service providers, analog and/or digital AM/FM radio service providers, SMS/MMS push service providers, Internet content or access providers.

The broadcast network 114 may include a radio transmission of Internet Protocol (IP) datacasting over DVB and/or DVB-H. The broadcast network 114 may broadcast a service such as a digital or analog television signal and supplemental content related to the service via transmitter 118. The broadcast network may also include a radio, television or IP datacasting broadcasting network. The broadcast network 114 may also transmit supplemental content, which may include a television signal, audio and/or video streams, data streams, video files, audio files, software files, and/or video games. In the case of transmitting IP datacasting services, the service source 122 may communicate actual program content to user device 112 through the broadcast network 114 and additional information such as user right and access information for the actual program content through the cellular network 116.

The mobile device 112 may also contact the service source 122 through the cellular network 116. The cellular network 116 may include a wireless network and a base transceiver station transmitter 120. The cellular network may include a second/third-generation (2G/3G) cellular data communications network, a Global System for Mobile communications network (GSM), or other wireless communication network such as a WLAN network.

In one aspect of the invention, mobile device 112 may include a wireless interface configured to send and/or receive digital wireless communications within cellular network 116. The information received by mobile device 112 through the cellular network 116 or broadcast network 114 may include user selection, applications, services, electronic images, audio clips, video clips, and/or WTAI (Wireless Telephony Application Interface) messages. As part of cellular network 116, one or more base stations (not shown) may support digital communications with receiver device 112 while the receiver device is located within the administrative domain of cellular network 116.

Examples of other digital broadcast standards which digital broadband broadcast system 110 may utilize include Digital Video Broadcast-Terrestrial (DVB-T), Integrated Services Digital Broadcasting-Terrestrial (ISDB-T), Advanced Television Systems Committee (ATSC) Data Broadcast Standard, Digital Multimedia Broadcast-Terrestrial (DMB-T), Terrestrial Digital Multimedia Broadcasting (T-DMB), Satellite Digital Multimedia Broadcasting (S-DMB), Forward Link Only (FLO), Digital Audio Broadcasting (DAB), and Digital Radio Mondiale (DRM). Other digital broadcasting standards and techniques, now known or later developed, may also be used. An aspect of the invention is also applicable to other multicarrier digital broadcast systems such as, for example, T-DAB, T/S-DMB, ISDB-T, ATSC, MediaFLO/FLO, non-traditional systems such 3GPP MBMS (Multimedia Broadcast/Multicast Services) and 3GPP2 BCMCS (Broadcast/Multicast Service).

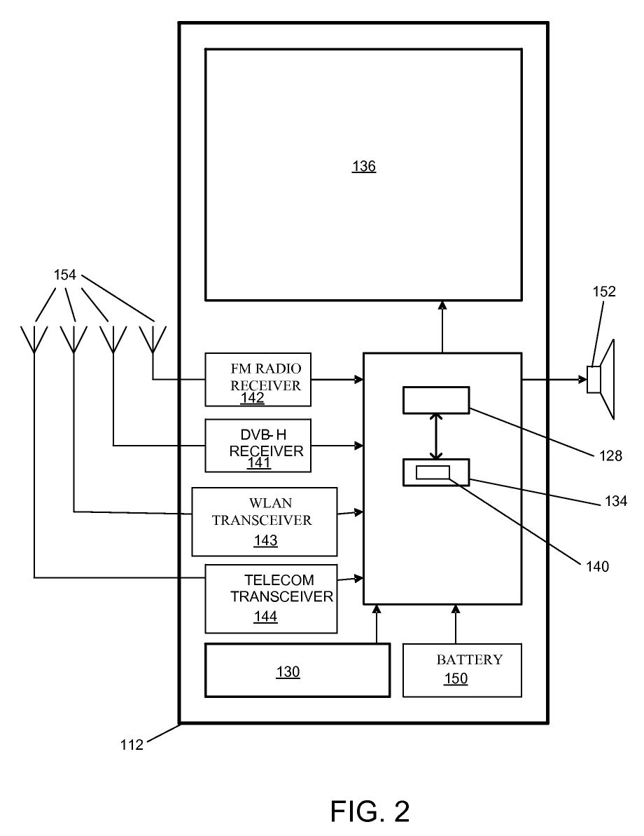

As shown in FIG. 2, mobile device 112 may include processor 128 connected to user interface 130, memory 134 and/or other storage, and display 136. Mobile device 112 may also include battery 150, speaker 152 and antennas 154. User interface 130 may further include at least one input device (not shown) such as keypad, touch screen, voice interface, one or more arrow keys, joy-stick, data glove, mouse, roller ball, touch screen, or the like.

Computer executable instructions and data used by processor 128 and other components within mobile device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile device 112 to perform various functions. Alternatively, some or all of mobile device 112 computer executable instructions may be embodied in hardware or firmware (not shown).

Mobile device 112 may be configured to receive, decode and process digital broadband broadcast transmissions that are based, for example, on the Digital Video Broadcast (DVB) standard, such as DVB-H or Digital Video Broadcasting Multimedia Home Platform (DVB-MHP), through a specific DVB-H receiver 141. The mobile device may also be provided with other types of receivers for digital broadband broadcast transmissions. Additionally, receiver device 112 may also be configured to receive, decode and process transmissions through FM/AM Radio receiver 142, WLAN transceiver 143, and telecommunications transceiver 144. In one aspect of the invention, mobile device 112 may receive radio data stream (RDS) messages.

In an example of the DVB standard, one DVB 10 Mbps transmission may have 200, 50 kbps audio program channels or fifty, 200 kbps video (TV) program channels. The mobile device 112 may be configured to receive, decode, and process transmission based on the Digital Video Broadcast-Handheld (DVB-H) standard or other DVB standards, such as DVB-MHP, DVB-Satellite (DVB-S), DVB-Terrestrial (DVB-T) or DVB-Cable (DVB-C). Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting-Terrestrial), DAB (Digital Audio Broadcasting), DMB (Digital Multimedia Broadcasting), FLO (Forward Link Only) or DIRECTV. Additionally, the digital transmission may be time sliced, such as in DVB-H technology.

In addition, an Electronic Service Guide (ESG) may be used to provide program or service related information. Generally, an Electronic Service Guide (ESG) enables a terminal to communicate what services are available to end users and how the services may be accessed. The ESG includes independently existing pieces of ESG fragments. Traditionally, ESG fragments include XML documents, but more recently they have encompassed a vast array of items, such as for example, a SDP (Session Description Protocol) description, textual file, or an image. The ESG fragments describe one or several aspects of currently available (or future) service or broadcast program. Such aspects may include for example: free text description, schedule, geographical availability, price, purchase method, genre, and supplementary information such as preview images or clips. Audio, video and other types of data including the ESG fragments may be transmitted through a variety of types of networks according to many different protocols. For example, data can be transmitted through a collection of networks usually referred to as the “Internet” using protocols of the Internet protocol suite, such as Internet Protocol (IP) and User Datagram Protocol (UDP). Data is often transmitted through the Internet addressed to a single user. It can, however, be addressed to a group of users, commonly known as multicasting. In the case in which the data is addressed to all users it is called broadcasting.

One way of broadcasting data is to use an IP datacasting (IPDC) network. IPDC is a combination of digital broadcast and Internet Protocol. Through such an IP-based broadcasting network, one or more service providers can supply different types of IP services including on-line newspapers, radio, and television. These IP services are organized into one or more media streams in the form of audio, video and/or other types of data. To determine when and where these streams occur, users refer to an electronic service guide (ESG). One example used in digital video broadcasting (DVB) streams is an electronic program guide (EPG). One type of DVB is Digital video broadcasting-handheld (DVB-H). The DVB-H is designed to deliver 10 Mbps of data to a battery-powered terminal device.

A DVB-H network may carry IP flows of one or more IP platforms and an IP flow can be carried in different IP streams. An IP stream may be identified by one or more of the following: original network ID, transport stream ID, service ID, component tag, IP source address, and IP destination address. An IP Stream is encoded using the Multi-protocol Encapsulation (MPE) before transmission over the DVB-H network. MPE-FEC is applied on each source data burst to produce repair data that is used for protection against transport errors. IP packets as well as the MPE-FEC repair data are mapped into MPE sections. MPE sections are then fragmented into transport stream (TS) packets and broadcast over the air.

In aspect of the invention, a virtual platform may be used to signal and identify platforms that carry services over multiple bearers. The bearers of a platform may comprise different technologies. In addition, the services carried within one bearer may also be carried over another bearer belonging to the same virtual platform.

In an embodiment, a provider may provide services such as service X and service Y over DVB-H broadcast access A using specification P. In addition, the same provider may provide service Z over another DVB-H broadcast access B using specification R. Finally, the same provider may provide services X, Y, and Z over 3G access C using specification Q. The provider system may create a virtual platform declaration message that includes various parameters such as virtual platform provider, virtual platform identifier, bearer type, bearer access parameters, and specification of the bearer. Those skilled in the art will realize that numerous additional parameters may be included in the virtual platform declaration message. For instance, additional parameters relating to each bearer belonging to the platform may also be included.

In an aspect of the invention, a virtual platform declaration message may have a virtual platform provider entitled “ProviderInc.” A virtual platform identifier such as “Basic Service” or “123” may be used to identify virtual platform provider “ProviderInc.” The virtual platform declaration message may further include bearer information. A bearer type such as “DVB-H” may be indicated. Those skilled in the art will realize that bearer type is not limited to DVB-H and may also comprise T-DAB, T/S-DMB, ISDB-T, ATSC, MediaFLO/FLO, non-traditional systems such 3GPP MBMS (Multimedia Broadcast/Multicast Services) and 3GPP2 BCMCS (Broadcast/Multicast Service), WLAN, DVB-H/T-DMB/(Media) FLO system, or any other digital or non-digital communications or broadcasting system or any combination of the above systems

A bearer access parameter such as cell identification, “cell_id,” and original network identification, “original_network_id,” may be indicated for the specified bearer type “DVB-H.” Finally, a specification for each bearer may be included such as DVB Convergence of Broadcast and Mobile Services (CBMS) Broadcast Mobile Convergence (BMCO) Profile.

In an aspect of the invention, a server may create a mapping between the cell_ids of different bearers (access points) to other cells having at least a partly overlapping coverage area and use the cell_ids for further virtual platform presentations.

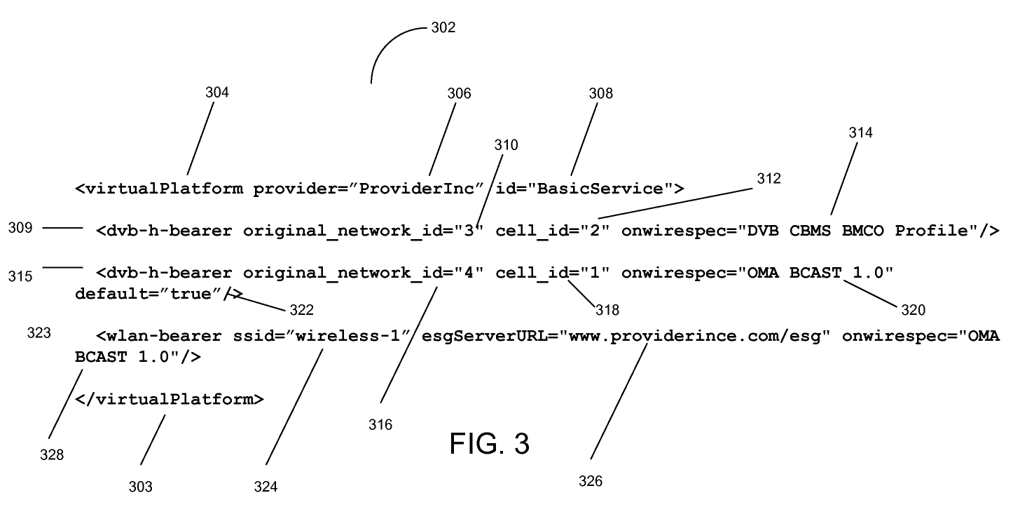

In an aspect of the invention, a provider may encode and instantiate a virtual platform declaration message in XML, HTML, in binary or in any other data representation format. For example, FIG. 3 illustrates a virtual platform declaration message 302. The element <virtualplatform> 303 may represent the bundling of two DVB-H bearers and one WLAN bearer as one virtual platform.

In another aspect of the invention, rendering and information related to the virtual platform may be accomplished in a self-contained way. In an embodiment, the virtual platform declaration may be instantiated as a HTML document, Scalable Vector Graphics (SVG) document, or any other renderable document. The renderable parts of the document are the rendered representation of the virtual platform. Within the renderable document the information—metadata itself: virtual platform declaration data—may be either instantiated as non-renderable elements or renderable elements. For example, the virtual platform declaration may be instantiated as an HTML document. Within the HTML document, the non-renderable elements may carry the actual data on virtual platform declaration. In an embodiment, such a self-contained virtual platform declaration may be delivered in the same way as the other types of instantiations of virtual platform declaration.”

The virtual platform declaration message 302 may include a virtual platform provider 304 such as virtual platform provider “ProviderInc” 306 and a virtual platform id such as “BasicService” 308. Those skilled in the art will realize that each provider may utilize a descriptive id to further identify their particular services. The virtual platform declaration message 302 may further include a first DVB-H bearer 309 that may operate on original_network_id “3” 310 and cell_id “2” 312 with an application layer signal on the bearer that conforms to a DVB CBMS BMCO Profile 314.

A shown in the virtual platform declaration message 302 of FIG. 3, a second DVB-H bearer 315 may operate on original network_id “4” 316 and cell_id “1” 318 with an application layer signal on the bearer that conforms to OMA BCAST 1.0 320. In addition, the second DVB-H bearer 315 may also include an indication that the second DVB-H bearer 315 is a default bearer (default=“true” 322). A default bearer indication may advise receiving terminals as to the preferred bearer for access.

Virtual platform declaration message 302 may also include a third WLAN bearer 323 with a service set identifier (ssid) of “wireless-1” 324. An ESG server of the system may be accessible over WLAN at “www.providerince.com/esg” 326 using an Open Mobile Alliance Mobile Broadcast Services (OMA BCAST) 1.0 protocol suite 328. In various aspects of the invention, the XML file may comprise other descriptive data and/or additional access parameters such as service schedules.

In another aspect of the invention, the system may distribute or otherwise make a virtual platform declaration message available over any combination of the following: 1) Bearers that are part of the virtual platform declaration itself; or 2) Bearers that are not included in the virtual platform declaration. Enabling a virtual platform declaration message to be available to bearers that are part of the virtual platform declaration may permit all included bearers to announce to other bearers that are also part of the same platform. Enabling a virtual platform declaration message to be available to bearers that are not included in the virtual platform network may allow the provider to provide a “boot” feature (using external bearer to carry the declaration of the platform).

Those skilled in the art will realize that numerous embodiments may be envisioned for carrying the virtual platform declaration message. For instance, the virtual platform declaration message may be distributed 1) within a DVB Fragment Container; 2) within an OMA BCAST Service Guide delivery unit (SGDU); 3) as an extension to DVB index container; 4) as an extension to OMA BCAST Service guide Delivery descriptor (SGDD); 5) in a UDP packet with know IP address; 6) in a UDP packet with know IP address and port; 7) within DVB Program Specific Information/Service Information (PSI/SI) tables; and 8) within FLO internal signalling. Those skilled in the art will realize that the list is exemplary as numerous additional ways of carrying the virtual platform declaration message may be utilized.

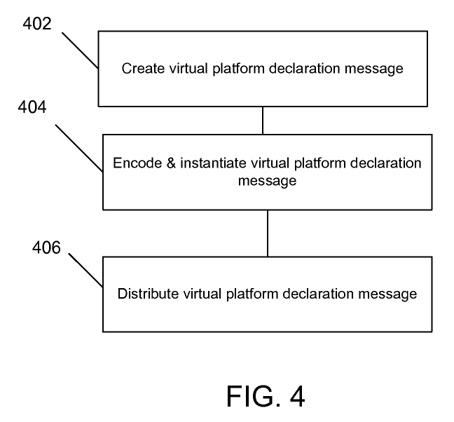

FIG. 4 illustrates a flow diagram showing the creation and transmission of a virtual platform declaration message in accordance with an aspect of the invention. In FIG. 4 at step 402, a provider system creates a virtual platform message indicating the services provided by the provider. At step 404, the system encodes and instantiated the virtual platform declaration message. Next, in step 406 the system transmits or distributes the virtual platform declaration message.

In another aspect of the invention, a terminal may receive the virtual platform declaration message and interpret the services offered by several platforms as a part of single service offering and/or single provider platform. In an embodiment, a terminal may decide to access each of the listed bearers to obtain an individual bearer specific service guide and to combine those into coherent end user view. In another embodiment, a terminal may decide to access bearer by bearer depending on the currently available reception conditions.

In an aspect of the invention, a terminal may acquire a virtual platform declaration message. The terminal may obtain the virtual platform declaration message from 1) DVB Fragment Container; 2) OMA BCAST SGDU; 3) extension to DVB index container; 4) extension to OMA BCAST SGDD; 5) UDP packet with know IP address; 6) UDP packet with know IP address and port; 7) DVB PSI/SI tables; and 8) FLO internal signalling.

Those skilled in the art will realize that other methods of receiving the virtual platform declaration message are also envisioned such as the terminal may have the declaration message preconfigured (programmed at the manufacturer). Moreover, the virtual platform declaration message may be provisioned with a device management feature. In this case, the virtual platform declaration may be a management object being provisioned and/or managed to the terminal. In another aspect of the invention, the virtual platform declaration message may be provisioned by some other feature. In yet another embodiment, the virtual platform declaration message may also be obtained by the terminal using HTTP over a bidirectional channel.

The terminal may store the virtual platform declaration message in volatile or non-volatile memory. The terminal may determine from the virtual platform declaration message the knowledge of currently available bearers. Using this information, the terminal may determine information such as how an ESG (Electronic Service Guide) bootstrapping/service discovery is provided. In addition, the terminal may determine additional information regarding the ESG such as information regarding protocols and how an ESG is delivered. Moreover, the terminal may determine 1) format of the ESG and data within the ESG; 2) data management of the ESG; 3) which protocols deliver stream and files; and 4) protection systems which may be used by the provider.

In another aspect of the invention, for each available bearer that matches the bearer declared in virtual platform declaration message, the bearer acquires the service guide. The terminal may use the information of available bearers, service guide and virtual platform declaration to display which services are available. The services that may be displayed may be highlighted with the remaining services either not displayed or greyed (not selectable).

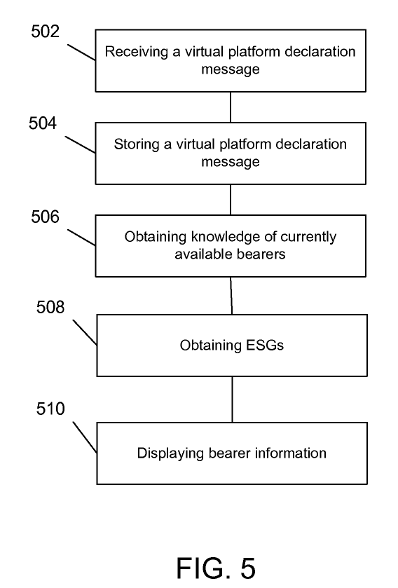

FIG. 5 illustrates a flow diagram showing receipt of a virtual platform declaration message by a terminal in accordance with an aspect of the invention. In FIG. 5, at 502 a terminal receives a virtual platform declaration message. The terminal may store the virtual platform declaration message at step 504. The virtual platform declaration message may be stored in terminal memory 134 (FIG. 2). Next, in step 506 the terminal may parse the virtual platform declaration message to obtain knowledge of the currently available bearers. In step 508, the terminal may obtain the service guide for each bearer that matches the bearers declared in the virtual platform declaration. Next in step 510, the terminal displays the available information for each of the bearers on a display of the terminal.

In another aspect of the invention, when the terminal attempts to access one of the determined bearers that are available (e.g. DVB-H, 3GPP, 3GPP2, WLAN, etc.) the terminal may receive the cell_id for that access point and may use this cell_id for searching the available virtual platforms e.g. from those that have been stored in the terminal and returning (only) those virtual platforms that have in their declaration the cell_id for the accessed service.

In another aspect of the invention, the terminal may set and store a time stamp for each of the virtual platforms showing when that virtual platform was accessed. The time stamps may be used for priority ordering of list(s) of virtual platforms.

The embodiments herein include any feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques.

We claim:

1. A method comprising:
receiving a virtual platform declaration message, the virtual platform declaration message identifying platforms that carry services over at least one bearer;
parsing the virtual platform declaration message;
determining at least one available bearer from the parsed virtual platform declaration message; and
displaying an identification of the at least one available bearer.

2. The method of claim 1, further comprising receiving a service guide for the determined at least one available bearer.

3. The method of claim 1, further comprising displaying available services for the determined at least one available bearer.

4. The method of claim 1, wherein virtual platform declaration message comprises a bearer type.

5. The method of claim 1, wherein the virtual platform declaration message comprises a bearer access parameter.

6. The method of claim 1, wherein the virtual platform declaration message comprises a bearer's specification.

7. The method of claim 1, wherein the virtual platform declaration message comprises a virtual platform identifier.

8. An apparatus comprising;
a memory configured to store a virtual platform declaration message, the virtual platform declaration message identifying platforms that carry services over at least one bearer; and
a processor coupled to the memory, the processor configured to parse the declaration message and determine at least one available bearer from the parsed virtual platform declaration message.

9. The apparatus of claim 8, further comprising a display, the display configured to display the determined at least one available bearer.

10. The apparatus of claim 8, wherein virtual platform declaration message comprises a bearer type.

11. The apparatus of claim 8, wherein the virtual platform declaration message comprises a bearer access parameter.

12. The apparatus of claim 8, wherein the virtual platform declaration message comprises a bearer's specification.

13. The apparatus of claim 8, wherein the virtual platform declaration message comprises a virtual platform identifier.

14. A method comprising:
creating a virtual platform declaration message, the virtual platform declaration message identifying platforms that carry services over at least one bearer;
encoding and instantiating the virtual platform declaration message; and
distributing the virtual platform declaration message.

15. The method of claim 14, wherein the virtual platform declaration message is encoded and instantiated with a markup language.

16. The method of claim 14, wherein virtual platform declaration message comprises a bearer type.

17. The method of claim 14, wherein the virtual platform declaration message comprises a bearer access parameter.

18. The method of claim 14, wherein the virtual platform declaration message comprises a bearer's specification.

19. The method of claim 14, wherein the virtual platform declaration message comprises a virtual platform identifier.

20. An apparatus comprising;
a memory;
a processor coupled to the memory, the processor configured to create a virtual platform declaration message, the virtual platform declaration message identifying platforms that carry services over at least one bearer; and
a transmitter configured to transmit the created virtual platform declaration message.

21. The apparatus of claim 20, wherein virtual platform declaration message comprises a bearer type.

22. The apparatus of claim 20, wherein the virtual platform declaration message comprises a bearer access parameter.

23. The apparatus of claim 20, wherein the virtual platform declaration message comprises a bearer's specification.

24. The apparatus of claim 20, wherein the virtual platform declaration message comprises a virtual platform identifier.
